(19) United States
(12) Patent Application Publication
(10) Pub. No.: US 2019/0354956 A1
(43) Pub. Date: Nov. 21, 2019

(54) MOBILE TERMINAL AND PAYMENT METHOD USING THE SAME

(71) Applicant: LG ELECTRONICS INC., Seoul (KR)

(72) Inventors: Hyunok LEE, Seoul (KR); Cheol KANG, Seoul (KR); Cheegoog KIM, Seoul (KR); Woonghee PARK, Seoul (KR); Mansoo SIN, Seoul (KR); Changseok CHO, Seoul (KR); Hyungjoo CHEON, Seoul (KR); Kyungsoo HWANG, Seoul (KR); Sanghoon HWANG, Seoul (KR)

(73) Assignee: LG ELECTRONICS INC., Seoul (KR)

(21) Appl. No.: 16/263,936

(22) Filed: Jan. 31, 2019

(30) Foreign Application Priority Data
May 17, 2018 (KR) 10-2018-0056487

(51) Int. Cl. G06Q 20/32; G06Q 20/40; G07C 9/00

(52) U.S. Cl. CPC G06Q 20/3224; G06Q 20/3278; G07C 2009/00507; G07C 9/00309; G06Q 2240/00; G06Q 20/405

(57) ABSTRACT

A mobile terminal including a wireless communication unit configured to communicate with a plurality of Low Frequency (LF) antennas installed in a vehicle; and a controller configured to check a relative position relationship between the vehicle and the mobile terminal, based on field values of the LF antennas received via the communication unit, and control execution of a payment application on the mobile terminal based on the relative position relationship between the vehicle and the mobile terminal.

### CROSS-REFERENCE TO RELATED APPLICATION

This non-provisional application claims the benefit under 35 U.S.C. § 119(a) to Patent Application No. 10-2018-0056487, filed in the Republic of Korea on May 17, 2018, which is hereby expressly incorporated by reference into the present application.

### BACKGROUND OF THE INVENTION

### Field of the Invention

The present invention relates to a mobile terminal capable of communicating with a vehicle through a Passive Keyless Entry (PKE) system and a payment method using the mobile terminal.

### Related Art

Terminals can be divided into mobile/portable terminals and stationary terminals. Mobile terminals can be further divided into handheld terminals and vehicle-mounted terminals.

Mobile terminals have become increasingly more functional. Examples of such functions include data and voice communications, capturing images and video via a camera, recording audio, playing music files via a speaker system, and displaying images and video on a display. Some mobile terminals include additional functionality which supports game playing, while other terminals are configured as multimedia players. More recently, mobile terminals have been configured to receive broadcast and multicast signals which permit viewing of content such as videos and television programs.

As functions of mobile terminals have become increasingly diversified, more and more mobile terminals are implemented in the form of multimedia devices providing compound functions such as capturing images or videos, playing music or video files, playing games, and receiving broadcast programs. Efforts are ongoing to support and increase the functionality of mobile terminals. Such efforts include software and hardware improvements, as well as changes and improvements in the structural components.

Recently, research is being conducted actively to develop a method for embedding a smart key for controlling basic functions of a vehicle into a mobile terminal, for example, a smart phone. A smart key system includes a Remote Keyless Entry (RKE) system through which a vehicle owner can open or close a door of a vehicle without using a key and a Passive Keyless Entry (PKE) system through which a vehicle owner can control opening or closing a door of a vehicle wirelessly.

The PKE system can control a vehicle remotely over long distances (within a few tens of meters) through RF frequency bands (313 MHz, 434 MHz, and 903 MHz). The PKE system can control a vehicle through low power, short-distance communication (within a few meters) in the Low Frequency (LF) frequency band (200 KHz or less). By using the distance between a vehicle and a smart key, the PKE system can provide a user with functions such as sending a welcome message, door unlock, engine start & stop, and locating a smart key inside or outside the vehicle.

### SUMMARY OF THE INVENTION

There is growing demand for a mobile terminal to support additional services in addition to such services like opening or closing a vehicle door or starting the engine. For example, it is demanded that a user can employ a mobile terminal to control a vehicle and pay make a payment while the user is seated in the vehicle.

To solve the technical problem above, an object of the present invention is to provide a mobile terminal capable of performing payment at various payment events in addition to controlling a vehicle and a method for controlling the mobile terminal.

A mobile terminal according to one aspect of the present invention includes a smart key module including a first communication unit detecting field values of a plurality of LF antennas installed in a vehicle and a second communication unit transmitting a signal for controlling the vehicle to the vehicle, a memory storing field values over distances for each of the plurality of LF antennas installed in the vehicle; and a controller analyzing a radio signal obtained through the first communication unit and controlling execution of a pay application. The controller detects the field value of a plurality of LF antennas installed in the vehicle through the first communication unit, compares the detected field values with those stored in the memory, checks a relative position relationship between the vehicle and the mobile terminal, and controls execution of the pay application based on the position of the mobile terminal.

A mobile terminal according to another aspect of the present invention includes a PKE module communicating with a vehicle through PKE communication protocol; a controller determining the vehicle state and a position of the mobile terminal based on a signal received through the PKE module from the vehicle and determining a payment event based on the state of the vehicle and the position of the mobile terminal; a payment processing unit being activated under the control of the controller and executing a pay application at the payment event. The pay application outputs user authentication information and payment processing information when a partner terminal or a high-pass gate requests payment and processes the payment.

The payment method for a mobile terminal includes detecting the vehicle state and the position of the mobile terminal based on LF antenna signals received sequentially through the PKE module from the vehicle and determining the vehicle state and the position of the mobile terminal; determining a payment event based on the vehicle state and the position of the mobile terminal; and executing a pay application at the payment event and performing payment requested by a partner terminal or a high-pass gate.

The present invention connects a mobile terminal to a vehicle, determines a payment event based on the vehicle state and the position of the mobile terminal, and automatically executes a pay application at the payment event through a PKE system. As a result, the present invention is capable of not only controlling a vehicle by using a mobile terminal but also performing payment automatically without involving a user command or a user input at various payment events.

### BRIEF DESCRIPTION OF THE DRAWINGS

The present invention will become more fully understood from the detailed description given hereinbelow and the accompanying drawings, which are given by illustration only, and thus are not limitative of the present invention, and wherein:

FIG. 1A is a block diagram of a mobile terminal according to an embodiment of the present disclosure.

FIG. 1B is a diagram showing the configuration of a mobile payment system using the mobile terminal according to an embodiment of the present invention.

FIG. 2 illustrates a mobile terminal and a PKE system of a vehicle according to an embodiment of the present invention.

FIG. 3 illustrates a user getting into a vehicle.

FIG. 4 illustrates an authentication process performed between a mobile terminal and a vehicle.

FIG. 5 is a flow diagram illustrating a method for executing a pay application while a vehicle is stopped and vehicle doors are closed.

FIG. 6 illustrates a vehicle state when a payment event occurs while the user is riding the vehicle.

FIG. 7 illustrates a movement path of a mobile terminal when the user performs payment by using the mobile terminal while riding the vehicle.

FIG. 8 illustrates information displayed on a screen of a mobile terminal when a pay application is executed.

FIG. 9 illustrates one example of a user authentication method in the pay application.

FIG. 10 illustrates one example in which the pay application is not executed automatically at a payment event.

FIG. 11 illustrates communication between a mobile terminal and a shop terminal.

FIG. 12 illustrates a payment distance when a user performs payment while riding the vehicle.

FIG. 13 illustrates a movement path of a mobile terminal after payment is done while the user is riding the vehicle.

FIG. 14 illustrates one example of a payment completion message displayed on the screen of the mobile terminal after payment.

FIG. 15 is a flow diagram illustrating a first payment attempt, payment completion, and a second payment attempt according to a payment method of the present invention.

FIG. 16 illustrates a first payment attempt, payment completion, and a second payment attempt between a mobile terminal and a partner terminal.

FIG. 17 illustrates a method for automatically executing a pay application of the mobile terminal in a gas station.

FIG. 18 illustrates a communication channel among a mobile terminal, a high-pass terminal, and a vehicle.

FIG. 19 illustrates an example in which a V2X module is embedded into a mobile terminal.

FIG. 20 illustrates a high-pass gate signal reception rate according to the position of a mobile terminal equipped with a V2X module within a vehicle.

FIG. 21 illustrates a method for paying a high-pass toll by using a mobile terminal equipped with a V2X module.

FIG. 22 illustrates a method for guiding a position change of a mobile terminal equipped with a V2X module.

### DESCRIPTION OF EXEMPLARY EMBODIMENTS

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

Although the terms including ordinal numbers such as first, second, etc. may be used herein to describe various elements, these elements should not be limited by these terms. These terms are generally only used to distinguish one element from another. When an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context. Terms such as “include” or “has” are used herein and should be understood that they are intended to indicate existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like. By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

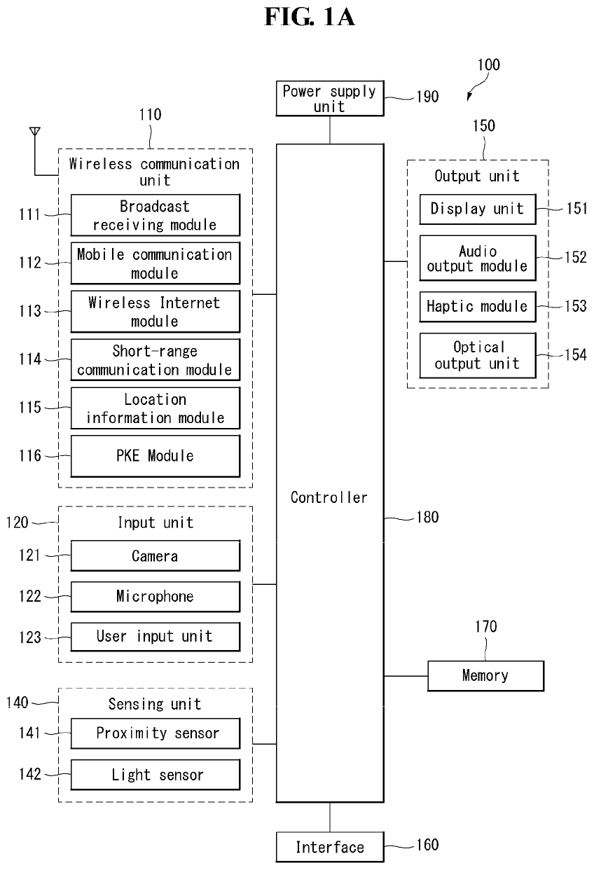

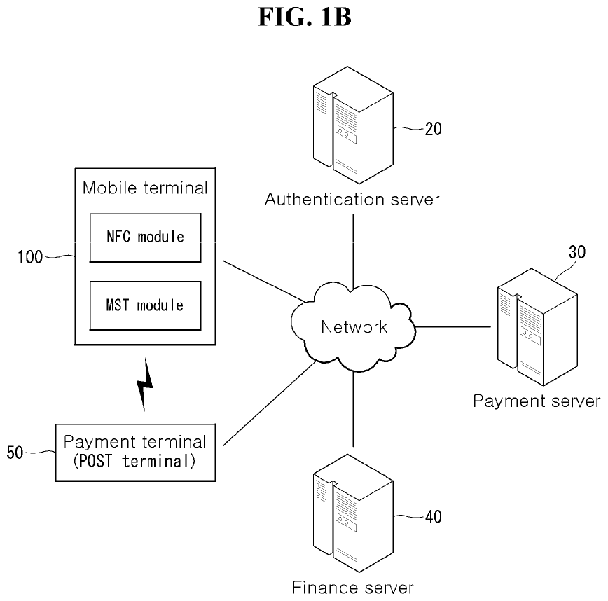

FIG. 1A is a block diagram of a mobile terminal in accordance with the present disclosure. The mobile terminal 100 is shown having components such as a wireless communication unit 110, an input unit 120, a sensing unit 140, an output unit 150, an interface unit 160, a memory 170, a controller 180, and a power supply unit 190. Implementing all of the illustrated components is not a requirement, and that greater or fewer components may alternatively be implemented.

Referring now to FIG. 1A, the mobile terminal 100 is shown having wireless communication unit 110 configured with several commonly implemented components. For instance, the wireless communication unit 110 typically includes one or more components which permit wireless communication between the mobile terminal 100 and a wireless communication system or network within which the mobile terminal is located.

The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks. To facilitate such communications, the wireless communication unit 110 includes one or more of a broadcast receiving module 111, a mobile communication module 112, a wireless Internet module 113, a short-range communication module 114, and a location information module 115. Also, the wireless communication unit 110 further includes a PKE module 116 connected to the vehicle 200 through a wireless communication channel. The PKE module 116 is considered to be the same as a smart key module.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. If desired, the sensing unit 140 may alternatively or additionally include other types of sensors or devices, such as proximity sensor 141, illumination sensor 142, a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor), and a chemical sensor (for example, an electronic nose, a health care sensor, and a biometric sensor), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information such as audio, video, and tactile output. The output unit 150 may include at least one of a display unit 151, an audio output module 152, a haptic module 153, and an optical output module 154. The display unit 151 may have an inter-layered structure or an integrated structure with a touch sensor in order to facilitate a touch screen. The touch screen can provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 can perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The memory 170 stores payment processing information associated with a pay application (PAY APP). The payment processing information may include credit card information or high-pass payment card preset to the mobile terminal 100 by the user. The PAY APP outputs user authentication information and payment processing information when a partner terminal or a high-pass gate requests payment and processes the payment.

The controller 180 typically functions to control overall operation of the mobile terminal 100, in addition to the operations associated with the application programs. The controller 180 can provide or process information or functions appropriate for a user by processing signals, data, information and the like, which are input or output by the various components depicted in FIG. 1A, or activating application programs stored in the memory 170.

Also, the controller 180 controls some or all of the components illustrated in FIG. 1A according to the execution of an application program that have been stored in the memory 170. Furthermore, to execute the application program, the controller 180 can combine at least two or more constituting elements belonging to the mobile terminal 100.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

At least part of the constituting elements above can operate in conjunction with each other to implement the operation or control of the mobile terminal according to various embodiments described below or a control method thereof. Also, the operation or control of the mobile terminal or a control method thereof may be implemented on the mobile terminal by executing at least one application program stored in the memory 170.

In what follows, before describing various embodiments implemented through the mobile terminal 100 described above, various components described above will now be described in more detail with reference to FIG. 1A. Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like).

Examples of wireless signals transmitted and/or received via the mobile communication module 112 include audio call signals, video (telephony) call signals, or various formats of data to support communication of text and multimedia messages. The wireless Internet module 113 is configured to facilitate wireless Internet access. This module may be internally or externally coupled to the mobile terminal 100. The wireless Internet module 113 can transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 can transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which can exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user can answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the mobile terminal. As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module. Depending on the needs, the location information module 115 may replace or additionally perform the function performed by a specific module of the wireless communication unit 110 to obtain data related to the position of the mobile terminal. The location information module 115 is used to obtain the position (or current location) of a mobile terminal and is not limited to a module which directly calculates or obtains the position of the mobile terminal.

The PKE module 116 is connected to the three-axis LF antenna and UHF RF antenna. The base station of the vehicle 200 activates LF antennas of the vehicle in a sequential order to transmit LF messages (LF RSSI reports). An LF message may include an LF ANT ID for identifying the vehicle. The PKE module 116 of the mobile terminal 100 receives an LF message of the LF frequency band through the three-axis LF antenna and transmits registered key information over the RF frequency band to perform user authentication. If the key information received by the vehicle 200 matches the key information of a pre-registered vehicle owner, the controller of the vehicle 200 executes a user command received from the mobile terminal 100. From the three-axis LF antenna embedded in the mobile terminal 100, if the mobile terminal 100 operates within the LF band, at which position the mobile terminal 100 is located with respect to the vehicle center may be identified accurately in terms of three-axis (X, Y, Z) coordinates. In the case of telematics or Bluetooth communication, it is impossible to know the position of the mobile terminal 100 inside a vehicle.

Next, the input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. Further, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared ray proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this instance, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like). In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others. As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 can sense which region of the display unit 151 has been touched. Here, the touch controller may be a component separate from the controller 180, the controller 180, and combinations thereof.

In some embodiments, the controller 180 can execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches include a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The pose detecting sensor can detect motion information such as existence of motion, movement distance, velocity, acceleration, and direction of the motion and/or attitude information such as a tilt angle of the mobile terminal 100 with respect to a predetermined rotation axis. The pose detecting sensor may include at least one acceleration sensor, at least one gyroscope (gyro sensor), or sensing signal processing unit compensating for a sensing value or converting sensing information.

The pose detecting sensor may obtain linear motion, rotational motion, and vibration information of the mobile terminal 100 from the acceleration detected through various sensors. The acceleration sensor detects the motion of the mobile terminal 100, obtains the acceleration of the motion, and detects information about existence of motion of the mobile terminal 100, movement distance, velocity, acceleration, and direction of the motion.

Also, the gyro sensor may obtain the amount of rotation by sensing rotational motion of the mobile terminal 100. The acceleration sensor may express the detected acceleration in terms of a vector of three-axis coordinate values (X, Y, and Z axis), and the gyroscope may express the detected angular speed in terms of rotation vector values (roll, pitch, and yaw) with respect to the three axis. By employing the acceleration sensor and the gyro sensor, the pose detecting sensor may determine the velocity, position, and position change of the mobile terminal 100. The pose detecting sensor may be implemented by a typical Inertial Navigation System (INS), and the gyro sensor may be an optical, mechanical, or piezoelectric type gyroscope.

Meanwhile, the sensing signal processing unit can convert an analog signal output from the acceleration sensor or gyroscope into an analog/digital signal, integrate the converted signal and track a trajectory to get information about motion, angle, and vibration. Up to this point, a pose detecting sensor including the acceleration sensor and the gyro sensor to obtain pose and motion of the mobile terminal according to one embodiment of the present invention has been described. However, the present invention is not limited to the specific description, and the motion and pose information of the mobile terminal 100 may also be obtained by using any sensor as long as it can obtain the object of the present invention.

In addition, the camera 121 typically includes at least one a camera sensor (CCD, CMOS etc.), a photo sensor (or image sensors), and a laser sensor. Implementing the camera 121 with a laser sensor may allow detection of a touch of a physical object with respect to a 3D stereoscopic image. The photo sensor may be laminated on, or overlapped with, the display device. The photo sensor can scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor can calculate the coordinates of the physical object according to variation of light to thus obtain position information of the physical object.

The display unit 151 can output information processed in the mobile terminal 100. For example, the display unit 151 can display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images. A typical stereoscopic display unit may employ a stereoscopic display scheme such as a stereoscopic scheme (a glass scheme), an auto-stereoscopic scheme (glassless scheme), a projection scheme (holographic scheme), or the like.

The audio output module 152 can output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented so the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle can operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc.), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 typically controls the general operations of the mobile terminal 100. For example, the controller 180 can set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provides internal power and supply the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected. As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance. Various embodiments described herein may be implemented in a computer-readable medium, a machine-readable medium, or similar medium using, for example, software, hardware, or any combination thereof.

Hereinafter, embodiments related to a control method that may be implemented in the mobile terminal configured as above are described with reference to the accompanying drawings. It is evident to those skilled in the art that the present invention may be implemented in other specific forms without departing from the spirit and essential characteristics of the present invention.

FIG. 1B is a diagram showing the configuration of a mobile payment system using the mobile terminal according to an embodiment of the present invention. Referring to FIG. 1B, the mobile payment system may include the mobile terminal 100, an authentication server 20, a payment server 30, a financial server 40 and a payment terminal (or POS terminal) 50. The elements of the payment system shown in FIG. 1B may be interconnected over a network. For example, the mobile terminal 100, the authentication server 20, the payment server 30, and the financial server 40 may be interconnected over a mobile communication network or through the Internet. Furthermore, for example, the mobile terminal 100 and the POS terminal 50 may be interconnected over a short-distance communication network, for example, near field communication (NFC), wireless-fidelity (Wi-Fi) or magnetic secure transmission (MST).

The mobile terminal according to an embodiment of the present invention can perform a process for payment information registration and deletion or user authentication necessary for a payment process using the mobile payment system. The mobile terminal 100 may be a device that is used by a user when the user attempts to perform mobile payment according to an embodiment of the present invention. The user can perform payment online/offline using the mobile terminal 100.

For example, the mobile terminal 100 can provide a payment service using a payment app (e.g., LG Pay Application). The payment app can provide a user interface related to payment. For example, the payment app can provide a user interface related to card registration, payment or transaction. Furthermore, the payment app can provide an authentication interface related to user authentication.

The mobile terminal 100 can also store card information or payment account information associated with a payment service account (e.g., LG account), a bio authentication service account or a user account. Further, the mobile terminal 100 can perform user authentication through an authentication process. The authentication process may be a bio authentication method based on a user's bio information or the authentication process may be a preset fin number entry method.

The mobile terminal 100 can request a payment token from the payment server 30, and can perform mobile payment using the payment token issued by the financial server 50. The mobile terminal 100 according to an embodiment of the present invention can operate in a common payment mode (or first payment mode) in which mobile payment is performed through a process of transmitting/receiving information necessary for payment with the authentication server 20, the payment server 30 and the financial server 40 connected thereto over a network.

The authentication server 20 can perform user authentication in response to a request from the mobile terminal 100. For example, the authentication server 20 can provide a fast identity online (FIDO) authentication service that performs user authentication using a user's bio information. Furthermore, for example, the authentication server 20 can perform user authentication using authentication information received from the mobile terminal 100.

The payment server 30 can transmit/receive information to/from the mobile terminal 100 and the financial server 40. The payment server 30 can manage card information or account information associated with a payment service account (e.g., LG Account), a bio authentication service account and a user account. When a payment token is requested by the mobile terminal 100, the payment server 30 can request the payment token from the financial server 40. The payment server 30 can then transfer the payment token received from the financial server 50 to the mobile terminal 100.

In addition, the financial server 40 may be server managed by a card company or a bank. The financial server 40 can issue a card and manage card information (or account information). Furthermore, the financial server 40 can generate a payment token. When a payment token request is received from the payment server 30, the financial server 40 can identify whether a user has been authenticated by the authentication server 20.

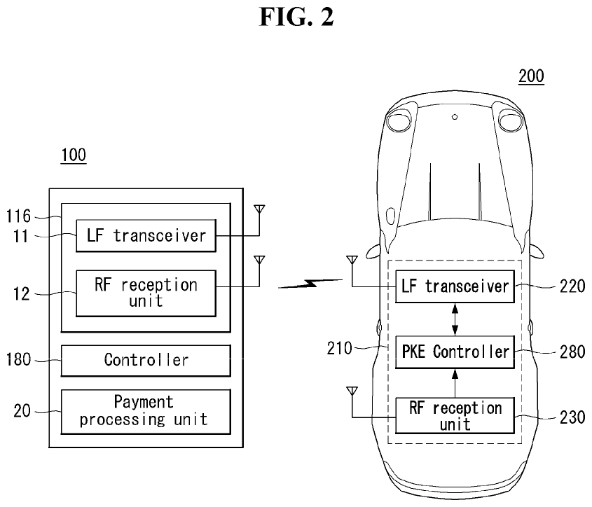

Next, FIG. 2 illustrates a mobile terminal 100 and a PKE system of a vehicle according to an embodiment of the present invention. Referring to FIG. 2, the PKE module 116 of the mobile terminal 100 includes an LF transceiver 11 connected to a three-axis LF antenna and an RF reception unit 12 connected to a UHF RF antenna.

The controller 180 detects a field value of the LF antenna signal of the vehicle 200 received through the LF transceiver 11 of the PKE module 116 and determines a relative position relationship between the vehicle 200 and the mobile terminal 100 by comparing the detected field value with a field value stored in the memory. Further, the controller 180 can determine whether a payment event is occurring from the relative position relationship between the vehicle 200 and the mobile terminal 100 and automatically execute the pay application of the payment processing unit 200 at the payment event.

In addition, the controller 180 analyzes a signal from the PKE module 116 and processes user authentication. In particular, the controller 180 substitutes RS RI received sequentially from the vehicle 200 through the LF transceiver into the triangulation equation and calculates the accurate position of the mobile terminal 100, thereby determining a relative position relationship between the vehicle 200 and the mobile terminal 100 accurately. The controller 180 also analyzes the position of the mobile terminal 100 and activates the payment processing unit 20 at the payment event.

Further, the payment processing unit 20 executes the pay application automatically at the payment event. In particular, the payment event means a situation in which the user has to perform payment by using the mobile terminal. Also, the pay application can operate payment-related devices embedded in the mobile terminal 100, for example, a microphone, speaker, camera, NFC module, backlight unit, and magnetic field transceiver. The payment processing unit 20 can also execute the pay application automatically each time a payment event occurs and thus the user does not have to execute the pay application.

The base station 210 of the vehicle 200 includes an LF transceiver 220 connected to a plurality of LF antennas, an RF reception unit 230 connected to a UHF RF antenna, and a PKE controller 280. The PKE controller 280 transmits an LF message by sequentially activating the LF antennas, analyzes key information of the mobile terminal received through the RF reception unit 230, processes user authentication, and executes a user command. The PKE controller 280, being coupled to the Electronic Control Unit (ECU) of the vehicle 200, can also transmit the vehicle state to the mobile terminal 100.

In addition, the mobile terminal 100 of the present invention calculates the position of the mobile terminal 100 within the LF region in real-time by using a signal received from the vehicle 200 by using the PKE system. The LF region indicates a range in which an LF antenna signal may be received.

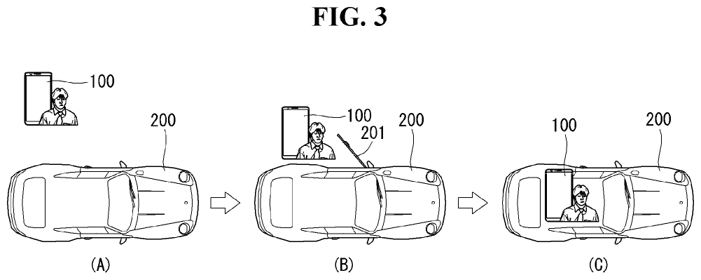

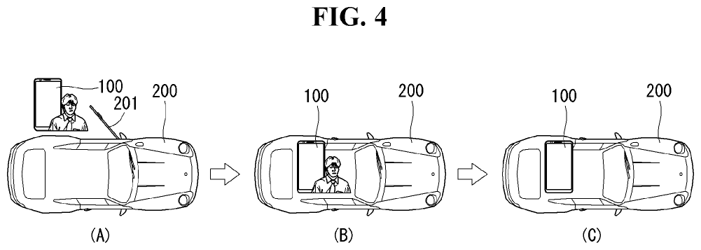

As shown in FIG. 3, the mobile terminal 100 automatically detects whether the user gets into a vehicle and performs authentication automatically in conjunction with the vehicle 200 as illustrated in FIG. 4. The mobile terminal 200 of the present invention can execute the pay application automatically when payment is performed for a drive-through service or when payment is performed at a gas station. In more detail, a drive-through service is such a kind of service which allows customers to purchase goods at a shop without parking their vehicle. The mobile terminal 100 calculates the position of the mobile terminal 100 within the LF region in real-time from a signal received from the vehicle 200 through the PKE communication protocol.

FIG. 3 illustrates a user getting into a vehicle. As shown in FIG. 3, the mobile terminal 100 moves with the user, and thus the mobile terminal 100 can be used to track the movement of the user approaching the vehicle 200 and getting into the vehicle 200 in real-time through the PKE communication protocol by substituting LF antenna field values of the vehicle 200 received through the PKE communication protocol into the triangulation equation and calculating the position of the mobile terminal 100 in real-time.

When the user carrying the mobile terminal 100 (A) approaches the vehicle 200, the mobile terminal 100 can detect that the position of the mobile terminal 100 is close to the vehicle 200 after authentication between the mobile terminal 100 and the vehicle 200 is successfully completed within the LF region. If the user opens the door of the vehicle 200 (B), the mobile terminal 100 can detect that the door of the vehicle 200 has been opened from a door auto unlock message received from the vehicle through the PKE module 116. The same wake up ID shared between the PKE modules 116 of the vehicle 200 and the mobile terminal 100 is set for the PKE system. After the wake up ID is authenticated, a PKE communication channel link is formed between the mobile terminal 100 and the vehicle 200.

Since the authentication process between the mobile terminal 100 and the vehicle 200 is handled through the PKE communication protocol, no separate pairing such as Bluetooth pairing is needed in the authentication process. Next, if the user gets into the vehicle and closes the doors (C), the mobile terminal 100 can detect that the doors of the vehicle 200 have been closed from a door lock message received from the vehicle 200 through the PKE module 116.

FIG. 4 illustrates an authentication process performed between a mobile terminal and a vehicle. Referring to FIG. 4, if authentication between the mobile terminal 100 and the vehicle 200 is successfully completed and the user gets into the vehicle 200 with the mobile terminal 100, the mobile terminal 100 can detect closing of the doors of the vehicle 200 through the PKE module 116 (A, B). If a payment event occurs while the mobile terminal 100 authenticated in the PKE system is inside the vehicle 200, the payment processing unit 20 can be executed automatically without involving a separate user command.

The mobile terminal 100 of the present invention detects a stop of the vehicle 200, turns on various sensors embedded in the mobile terminal 100 based on the detection result about the vehicle door state when the vehicle stops, and automatically determines which payment method (namely pay application) to use. The mobile terminal 100 can receive stop data from the vehicle through the PKE module 116 and detect the stop state of the vehicle 200 in real-time. Also, the mobile terminal 100 can detect that the vehicle 200 has stopped from the GPS module and motion sensor signal. The mobile terminal can determine a stop of the vehicle 200 by using Google awareness API.

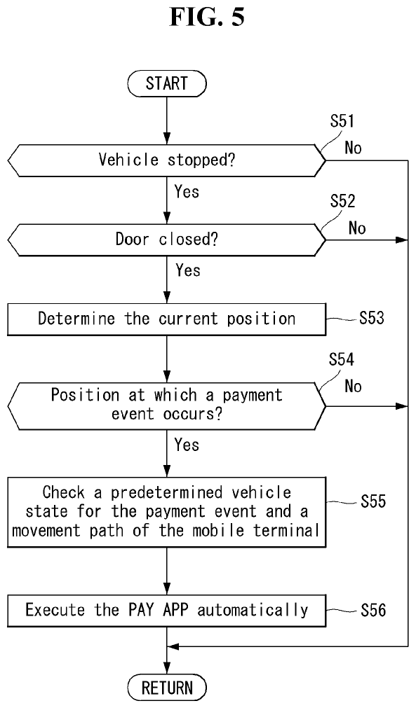

Next, FIG. 5 is a flow diagram illustrating a method for executing a pay application while a vehicle is stopped and vehicle doors are closed. Referring to FIG. 5, the mobile terminal 100 determines whether the vehicle 200 has stopped and vehicle doors are closed S51, S52. The mobile terminal 100 analyzes driving records and velocity before the vehicle 200 comes to a stop by using the GPS module and motion sensor and if it is analyzed that the vehicle was driving straight with a high speed before the vehicle stopped, it is determined that the vehicle has stopped due to a stop sign on the road.

If the vehicle 200 is stopped and vehicle doors are closed, the mobile terminal 100 determines the current position S53 by using the GPS module signal, for example. The mobile terminal 100 can also receive image data captured by a vehicle camera through the PKE communication protocol, and analyze the image data received by the vehicle camera to determine the current position of the vehicle 200 and the state thereof.

The mobile terminal 100 determines whether a payment event may occur at the current position of the vehicle 200 S54. The mobile terminal 100 can determine the location of the occurrence of the payment event based on the current location of the vehicle, payment record stored in the memory of the mobile terminal 100, sensor signal, and so on. The payment record refers to an accumulated history of whether a pay application of the mobile terminal 100 has been executed at the current location.

If the current location of the vehicle 200 is determined as the location of a payment event, the mobile terminal 100 checks a predetermined vehicle state for the payment event and a movement path of the mobile terminal 100, S55 and executes the pay application automatically S56.

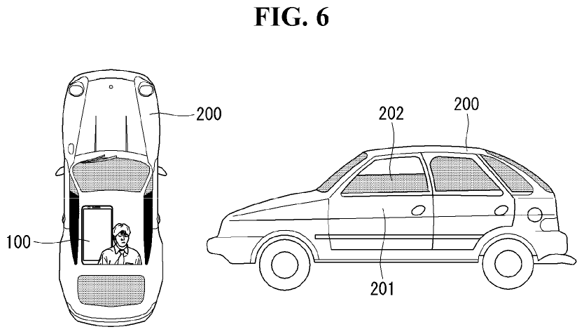

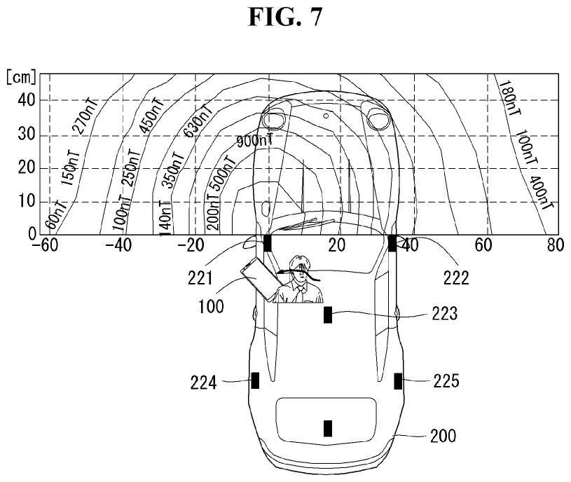

Next, FIGS. 6 and 7 show the predetermined vehicle state for the payment event and the movement path of the mobile terminal 100. The mobile terminal 100 compares a payment event count value with a predetermined threshold value and if the payment event count value is larger than the threshold value, determines that a payment event has occurred. The controller 180 of the mobile terminal 100 can read payment history data and assign a weight to the payment event count if there is an execution case of the pay application in the past at the current position. The mobile terminal 100 analyzes a gas detection sensor signal and if sensing a strong smell of oil, determines the current location as a gas station and assigns a weight to the payment event counter. Examining vehicle fuel data received through the PKE communication protocol, the mobile terminal 100 can determine the current location as a gas station if the amount of fuel in the vehicle 200 is small or increasing and assign a weight to the payment event count. If the mobile terminal 100 determines from the everyday schedule of the user stored in the memory that the current time is the mealtime and the current location is at a shop providing a drive-thru service (in what follows, it is called a drive-thru shop), a weight can be assigned to the payment event count.

In addition, the controller 180 of the mobile terminal 100 can determine a payment event by using the words recognized as payment events from a voice recognition result about the user's voice data, such as a gas station, hamburger, or fried potatoes. The mobile terminal 100 can also determine a payment event if an object such as a drive-thru shop, hamburger, or gas station is recognized in the image received through the PKE communication protocol.

To prevent a pay application (PAY APP) from being executed in non-payment event situations, the present invention determines the vehicle state and the position of a mobile terminal in real-time to improve accuracy of determining a payment event. In general, at a drive-thru shop or gas station, a driver opens a vehicle window 202 and pays by cash or credit card while the driver's door 201 of the vehicle is closed. The vehicle window 202 may be a driver's seat window.

Assuming the aforementioned situation, if the current location of the vehicle is at a payment event location as shown in FIG. 6, the driver's door 201 is closed, and the vehicle window 202 is opened, the mobile terminal 100 can determine occurrence of a payment event. Next, as shown in FIG. 7, if the mobile terminal 100 moves over the vehicle window 202 from the inside of the vehicle, the mobile terminal 100 can finally determine the occurrence of a payment event by using the PKE system and execute the pay application (PAY APP).

The mobile terminal 100 can also detect RS RI received from a base station of the vehicle 200 by using the LF ANT ID transmitted through an LF message, substitute the detected RS RI into the triangulation equation, and calculate the position of the mobile terminal 200 with respect to the center of the vehicle 200 in the form of 3D (X, Y, Z) coordinates in real-time. In FIG. 7, the symbols 221 to 225 represent LF antennas distributed across the vehicle. Since the LF antennas are spatially distributed inside the vehicle 200, the position of the mobile terminal 100 can be determined according to the received LF antenna IDs and signal strength.

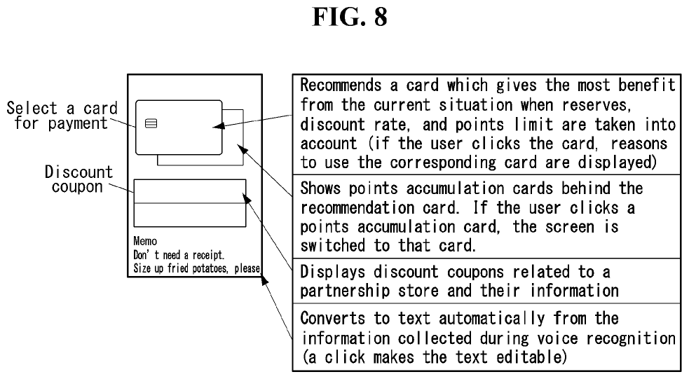

Next, FIG. 8 illustrates information displayed on a screen of a mobile terminal when a pay application is executed. Referring to FIG. 8, the mobile terminal 100 determines a payment event by using the PKE system and executes a PAY APP automatically. The PAY APP can provide a User Experience (UX) screen showing information such as coupon information related to card selection on the screen of the mobile terminal 100.

The PAY APP shows payment processing information (credit card) preset by the user and recommends payment processing information (recommendation card) which gives the user the most benefit from the current situation when reserves, discount rate, and points limit are taken into account. If the user clicks a recommendation card from the screen, rationale for recommending the corresponding card can be displayed. The PAY APP can also show points accumulation cards behind the recommendation card. If the user clicks a points accumulation card, the screen is switched to that card. The PAY APP can also display discount coupons related to the products of a partner company, for example, McDonald's products and their information on the screen of the mobile terminal 100.

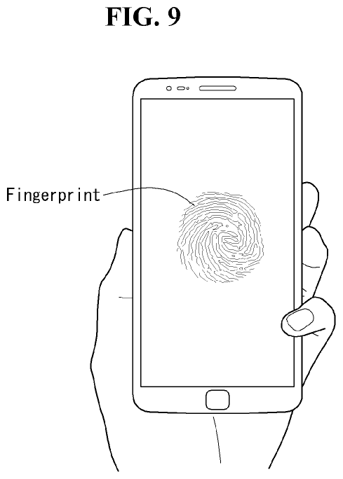

The PAY APP can convert items ordered by the user's voice into text, display the text on the screen of the mobile terminal 100 in the form of a memo, and provide a UX screen allowing the user to edit the contents of the memo when the memo is clicked. If the user sees a UX screen such as shown in FIG. 8 and selects payment processing information, the PAY APP performs user authentication like fingerprint authentication as shown in FIG. 9 and pays the price for a drive-thru shop or a gas station.

As described in the embodiments of FIGS. 5 to 7, a predetermined vehicle state and a movement path of the mobile terminal (user) determine a condition for the PAY APP to be executed automatically. When the driver door 201 of the vehicle is closed and the driver's seat window 202 is opened, the vehicle state satisfies the condition for automatic execution of the PAY APP; however, if the movement path of the mobile terminal 100 does not satisfy the condition for automatic execution of the PAY APP, the PAY APP is not executed to prevent a malfunction.

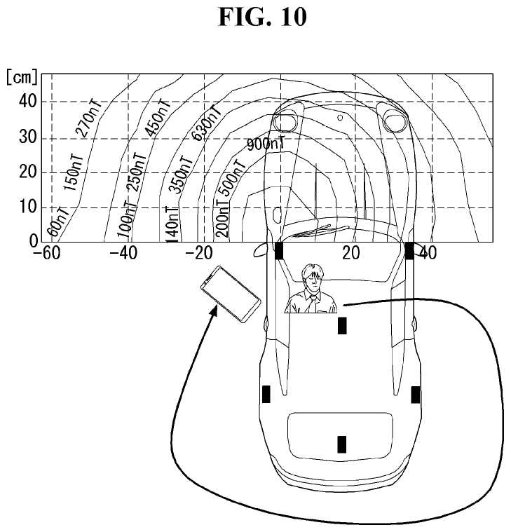

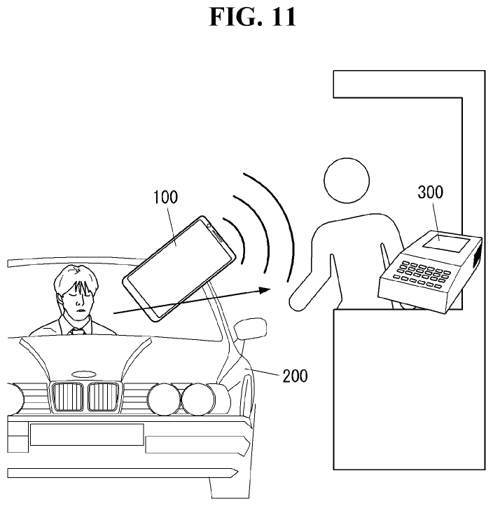

As one example, as shown in FIG. 10, instead of moving through the vehicle window 202, if the mobile terminal moves across the passenger seat, the PAY APP is not executed automatically. In this instance, the user can force the PAY APP to be executed for payment. At a payment event, the PAY APP is executed automatically when the mobile terminal 100 moves through the vehicle window 202. As shown in FIG. 11, the PAY APP performs wireless communication between the mobile terminal 100 and a partner terminal 300 at the shop for payment.

In addition, the PAY APP selects a communication method preferred by the partner terminal 300 and operates payment-related devices in the mobile terminal 100 automatically. Payment-related devices are such devices needed for communicating with the partner device 300 according to a payment method. For example, in the case of sound wave communication, the PAY APP of the mobile terminal 100 can turn on the microphone and speaker of the mobile terminal 100 and transmit information related to payment to the partner terminal 300 through sound wave communication to pay the price. The PAY APP can activate an NFC module of the mobile terminal 100 and transmit information related to payment to the partner terminal 300 through NFC to pay the price.

Further, the PAY APP can increase brightness of the backlight unit of the mobile terminal 100 to the maximum level, display a barcode or a QR code on the screen of the mobile terminal 100, and transmit information related to payment to the partner terminal 300 to pay the price. The PAY APP can operate the camera of the mobile terminal 100 and make the camera scan the QR code displayed on the partner terminal 300 to pay the price. The PAY APP can turn on the magnetic field (TX) of the mobile terminal 100 and transmit the magnetic field in which information related to payment is encoded to the partner terminal 300 to pay the price.

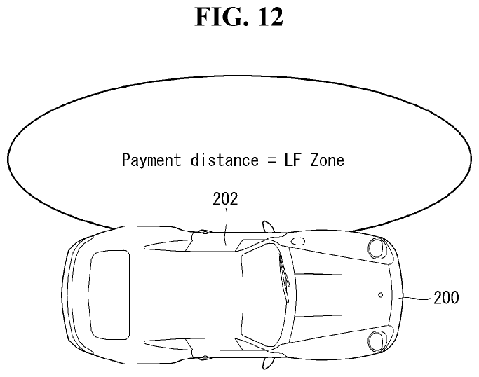

The payment distance of the mobile terminal which has got out of the vehicle 200 needs to be limited for security reason. As shown in FIG. 12, the payment distance can be set to an LF region of a predetermined size including the window 202 through which the mobile terminal 100 has got out of the vehicle. If the mobile terminal is beyond the payment distance, payment is prohibited automatically.

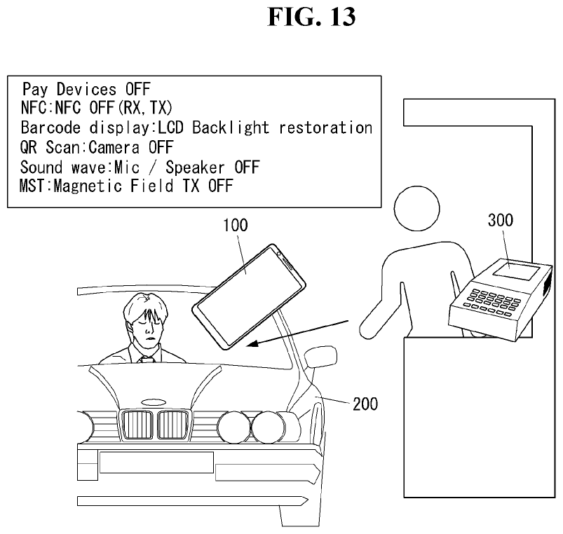

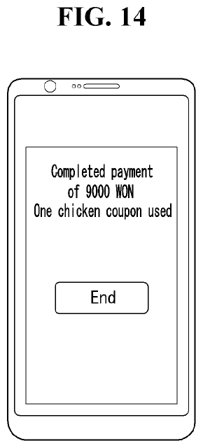

As shown in FIG. 13, after paying the price by using the mobile terminal 100, the user riding in the vehicle 200 brings the mobile terminal 100 back to the vehicle 200. Relying on the movement path of the mobile terminal 100, when the mobile terminal 100 comes back into the vehicle again through the very window 202 through which the mobile terminal 100 has moved out of the vehicle 200, the mobile terminal 100 deactivates the payment-related devices, stops operation of the devices, and displays payment details on the screen of the mobile terminal 100 as shown in FIG. 14. When the mobile terminal 200 comes back into the vehicle 200 after payment is completed, the mobile terminal 100 can detect its movement path through the PKE system.

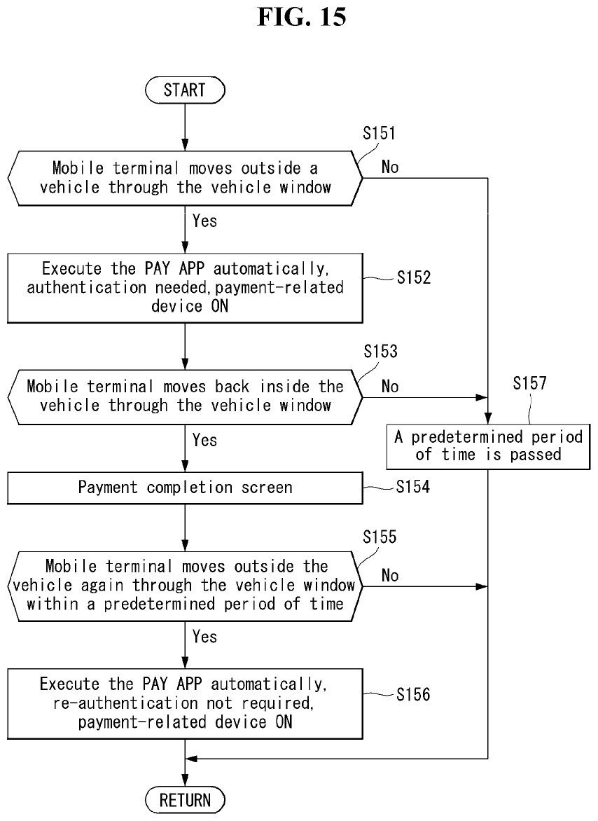

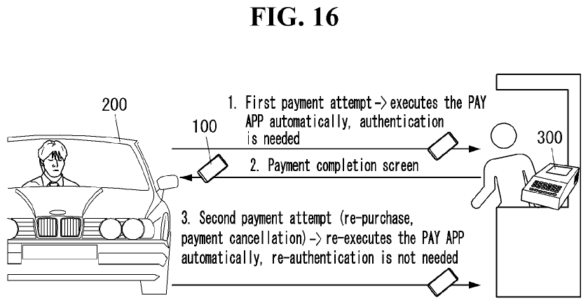

After payment is completed, the user can retry payment for reasons of repurchase or cancellation of payment. In this instance, while riding the vehicle, the user can again put the mobile terminal 100 toward the partner terminal 300 through the vehicle window 202. As shown in FIGS. 15 and 16, the mobile terminal 100 detects its movement path through the PKE communication protocol and automatically detects the PAY APP.

In more detail. FIG. 15 is a flow diagram illustrating a first payment attempt, payment completion, and a second payment attempt according to a payment method of the present invention, and FIG. 16 illustrates a first payment attempt, payment completion, and a second payment attempt between a mobile terminal and a partner terminal.

Referring to FIGS. 15 and 16, the mobile terminal 100 according to an embodiment of the present invention automatically executes the PAY APP when the mobile terminal 100 moves outside the vehicle through the vehicle window 202 at a payment event location S151, S152. The PAY APP selects a communication method for the partner terminal 300 to pay the price and drives payment-related devices. In the S152 step, payment is completed after the mobile terminal 100 completes user authentication.

If the mobile terminal 100 detects a movement path along which the mobile terminal 100 moves back into the vehicle 200 through the vehicle window 202 within a predetermined period of time after payment is completed, the mobile terminal 100 displays a payment completion screen on the screen of the mobile terminal 100 and deactivates the PAY APP and payment-related devices S153, S154.

The mobile terminal 100 can move outside the vehicle 200 through the vehicle window 202. If the mobile terminal 100 detects a movement path along which the mobile terminal 100 moves outside the vehicle through the vehicle window 202 within a predetermined period of time after payment is completed, the mobile terminal 100 determines the movement path as a repurchase or cancellation of payment situation and automatically executes the PAY APP again S155, S156. The PAY APP selects a communication method for the partner terminal 300 and drives payment-related devices again. In the S155 step, the PAY APP can process repurchase payment or cancellation of payment without involving user authentication. In the S151, S153 step, if the mobile terminal 100 does not go through the vehicle window 202 until a predetermine period of time is passed S157, the mobile terminal 100 deactivates the PAY APP and payment-related devices and terminates the payment event.

The user can add oil to the vehicle 200 for himself or herself at a self-service station and pay for the gasoline by using the mobile terminal 100. In this instance, the mobile terminal 100 communicates to the partner terminal 300 together with the user in the vicinity of the fuel tank cap outside the vehicle and pays the price.

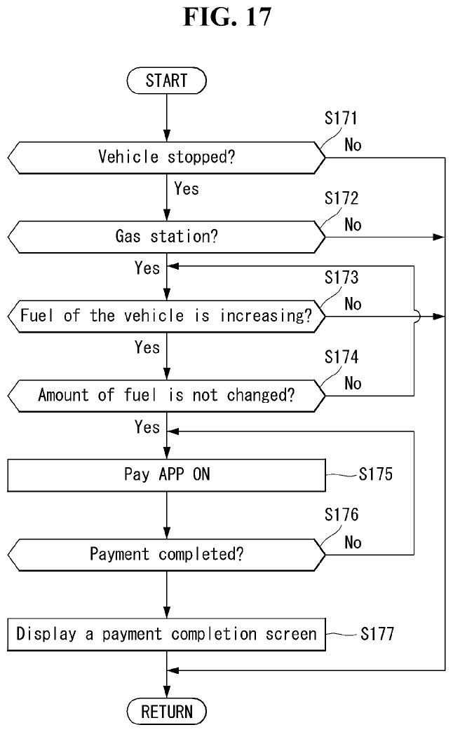

Next, FIG. 17 illustrates a method for automatically executing a pay application of the mobile terminal in a gas station. Referring to FIG. 17, the mobile terminal 100 can receive vehicle stop data from the vehicle 200 through the PKE communication protocol to monitor vehicle stop situations. The mobile terminal 100 can determine whether the vehicle is currently at a gas station through GPS, camera images, gas detection sensor, and so on.

If the mobile terminal 100 determines that the vehicle 200 has stopped at a gas station S171, S172, the mobile terminal 100 receive vehicle fuel data from the vehicle 200 through the PKE communication protocol. If the vehicle fuel data indicates that the amount of fuel in the vehicle 200 is increasing S173, the mobile terminal 100 determines that the user is currently adding fuel to the vehicle. Receiving position information of the mobile terminal 100 from the vehicle through the PKE communication protocol, the mobile terminal 100 can detect the position of the mobile terminal 100. If LF antenna signal intensity is increased in the vicinity of a fuel tank cap received by the mobile terminal 100 in the LF region outside the vehicle, it may be determined that the user is currently staying in a self-service station.

If the amount of fuel does not change for more than a predetermined period of time after the amount of fuel has increased, the mobile terminal 100 determines that the user has finished adding fuel to the vehicle S174. At this time, if the mobile terminal 100 detects through the PKE communication protocol that the user is in the vicinity of a fuel tank cap outside the vehicle, the mobile terminal 100 executes the PAY APP and payment-related devices automatically S175. The mobile terminal 100 executes the PAY APP and completes payment after user authentication S176. The PAY APP can select payment processing information suitable for the corresponding gas station, for example, oil company partnership credit card, and recommend the selected payment processing information for the user.

After the payment is completed, a payment completion screen is displayed on the screen of the mobile terminal 100 (S177). The payment completion screen may include payment card information, amount of fuel sold, mileage, and coupon information. After displaying the payment completion screen, the mobile terminal 100 deactivates the PAY APP and payment-related devices.

The mobile terminal of the present invention can pay a toll nonstop, for example, a high-pass toll, automatically through a high-pass toll payment card information embedded in the mobile terminal, existing high-pass terminal, or communication channel link connected to the PKE system of the vehicle.

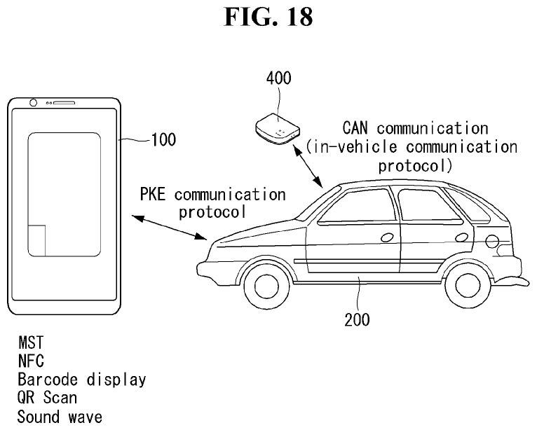

In more detail. FIG. 18 illustrates a communication channel among a mobile terminal, a high-pass terminal, and a vehicle. Referring to FIG. 18, the mobile terminal 100 of the present invention is connected to the vehicle 200 through the PKE communication protocol. If high-pass payment card information is stored in the mobile terminal 100, the PAY APP of the mobile terminal 100 can be executed automatically when the vehicle passes a high-pass gate which charges a toll.

The PAY APP of the mobile terminal 100 receives payment information for a toll from the vehicle 200 through the PKE communication protocol and Controller Area Network (CAN) which is an in-vehicle communication protocol and automatically performs user authentication and processes toll payment by using the high-pass payment card information embedded in the mobile terminal 100.

The high-pass terminal 400 is an On Board Equipment (OBE) performing short distance communication with a Road Side Equipment (RSE). The high-pass terminal 400 communicates with an RSE (5795-5815 MHz) through Dedicated Short Range Communication (DSRC) communication protocol while the vehicle is driving, transmits toll payment information received from the RSE to the ECU of the vehicle 100 through the CAN, and the base station 210 of the vehicle 100 transmits the toll payment information from the ECU to the PKE communication module of the mobile terminal. The PAY APP of the mobile terminal 100 is executed automatically when payment information is received through PKE communication and processes toll payment.

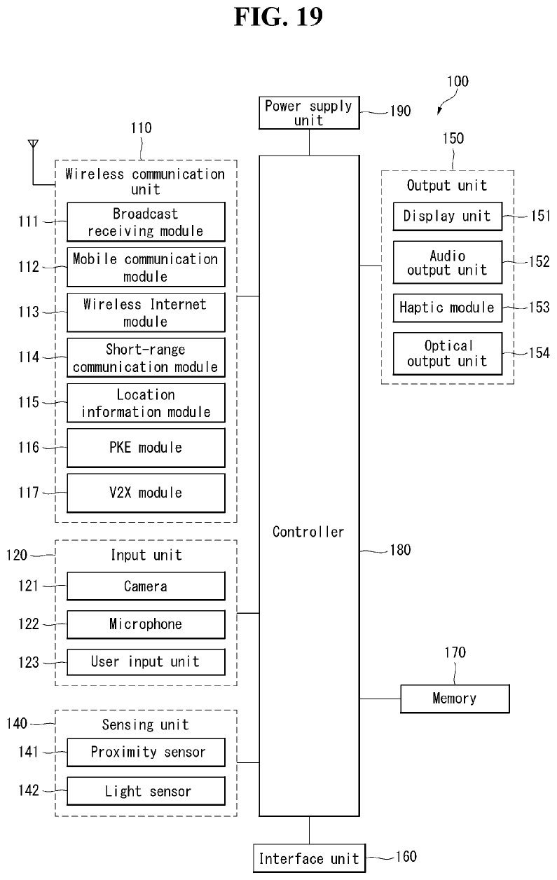

As shown in FIG. 19, the mobile terminal 100 of the present invention may further include a V2X module 117. The V2X module 117 can support the communication frequency specification (5795-5815 MHz) defined between a high-pass terminal 400 and an RSE, receives toll payment information without using a separate high-pass terminal 400, and transmit payment information to the RSE. The mobile terminal 100 may not only provide a navigation screen but also perform the function of a high-pass terminal.

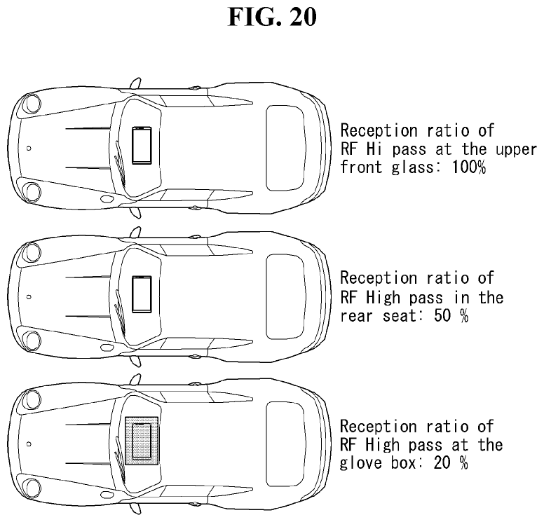

The reception ratio of a high-pass gate signal (RF Hi pass) in the 5795 to 5815 MHz band measured by the mobile terminal 100 in which the V2X module 117 is embedded differs depending on the position of the mobile terminal 100 inside the vehicle. As shown in FIG. 20, the reception ratio of the high-pass gate signal (RF Hi pass) is measured to be 100% at the upper front glass of the vehicle 200. Further, the reception ratio of the high-pass gate signal (RF High pass) in the rear seat of the vehicle is degraded down to about 50%, and the reception ratio of the high-pass gate signal (RF High pass) at the glove box of the vehicle 200 is further degraded to about 20%. Therefore, to pay the high-pass toll by using the mobile terminal 100, it is preferred to place the mobile terminal 100 near the upper front glass which is the optimal position inside the vehicle.

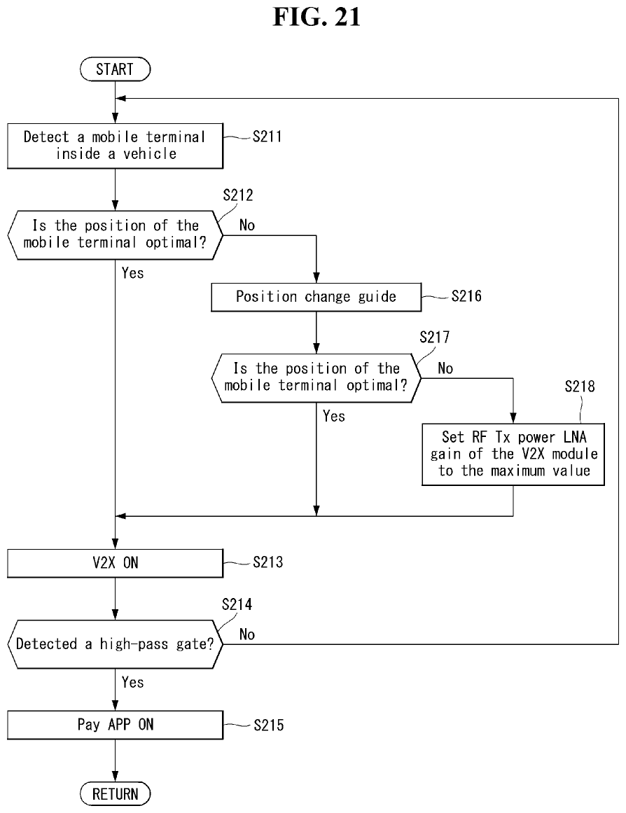

FIG. 21 illustrates a method for paying a high-pass toll by using a mobile terminal equipped with a V2X module. Referring to FIG. 21, the mobile terminal 100 receives location information indicating the current position of the mobile terminal 100 from the vehicle through the PKE communication protocol.

The mobile terminal 100 determines whether the current position of the mobile terminal 100 is the optimal position providing the highest reception ratio of a high-pass gate signal (RF Hi pass) inside the vehicle 200 based on location information received through PKE communication S211, S212.

If the mobile terminal 100 is located at the optimal position inside the vehicle 200, the mobile terminal 100 activates the V2X module 117, S213. The mobile terminal 100 receives a high-pass gate signal (RF Hi pass) through the V2X module 117 when a driving vehicle passes a high-pass gate and detects the high-pass gate S214. When the high-pass gate is detected, the mobile terminal 100 executes the PAY APP automatically S215. The PAY APP pays a toll received through the V2X module 117, generates a payment completion message, and transmits the message to the controller 180 of the mobile terminal 100, after which the controller 180 deactivates the PAY APP. The mobile terminal 100 transmits the payment completion message to the high-pass gate through the V2X module 118.

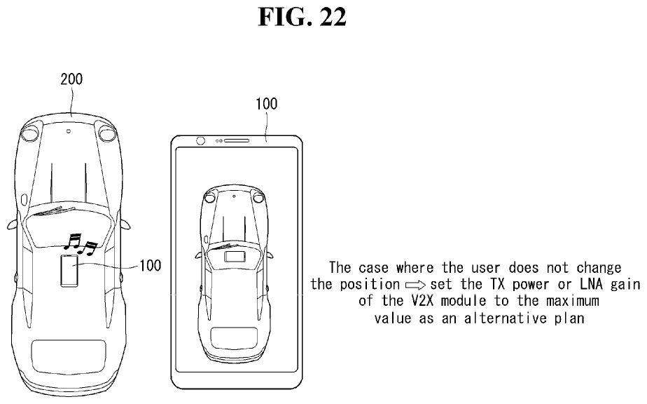

In the S212 step, if the mobile terminal 100 determines that its position is not optimal, the mobile terminal 100 can provide a guide requesting change of the position for the user. As shown in FIG. 22, a method for guiding a position change may output a position change message by a voice signal or display a position change message on the screen of the display unit S216.

If the position of the mobile terminal 100 does not move to the optimal position despite the position change guide S217, the mobile terminal 100 adjusts transmission (TX) power and LNA gain of the V2X module 118 to the maximum values to activate the V2X module 118, S218, S213. Meanwhile, the mobile terminal 100 monitors GPS data. If the mobile terminal 100 detects a situation where toll is not paid when the vehicle 200 passes a high-pass gate, the mobile terminal 100 executes the PAY APP automatically to pay the toll.

A credit card can provide various benefits to the user if predetermined minimum amount of payment is exceeded. In this regard, the PAY APP can change the high-pass payment card to another credit card when the accumulated payment amount of the high-pass payment card exceeds the minimum amount of payment for receiving benefits.

If high-pass payment card information is stored in the mobile terminal 100, the user can transmit the high-pass payment card information of the mobile terminal 100 to the high-pass terminal 400 through the vehicle without replacing a high-pass payment card to use a shared vehicle or a rent car.

The embodiments described above are not mutually exclusive or distinguished from each other. Individual structures or functions of the embodiments may be used separately or in combination therewith.

It is apparent for those skilled in the art that the present invention may be embodied in other specific forms without departing from the essential characteristics of the present invention. Therefore, the detailed descriptions above should be regarded as being illustrative rather than restrictive in every aspect. The technical scope of the present invention should be determined by a reasonable interpretation of the appended claims, and all of the modifications that fall within an equivalent scope of the present invention belong to the technical scope of the present invention.

What is claimed is:

1. A mobile terminal, comprising:
a wireless communication unit configured to communicate with a plurality of Low Frequency (LF) antennas installed in a vehicle; and
a controller configured to:
check a relative position relationship between the vehicle and the mobile terminal, based on field values of the LF antennas received via the communication unit, and
control execution of a payment application on the mobile terminal based on the relative position relationship between the vehicle and the mobile terminal.

2. The mobile terminal of claim 1, wherein the controller checks the relative position relationship between the vehicle and mobile terminal by:
detecting field values of the plurality of LF antennas installed in the vehicle through the communication unit, and
comparing the detected field values with stored field values of the LF antennas.

3. The mobile terminal of claim 1, wherein the relative position relationship of the mobile terminal comprises at least one among:
the mobile terminal being outside of the vehicle;
the mobile terminal being inside of the vehicle;
a movement path of the mobile terminal being from the inside of the vehicle to a left front seat in the vehicle, a left rear seat in the vehicle, a right front seat in the vehicle, or a right rear seat in the vehicle;
a movement path of the mobile terminal approaching the vehicle;
a movement path of the mobile terminal from the outside of the vehicle to the inside of the vehicle;
a movement path of the mobile terminal from the inside of the vehicle to the outside of the vehicle; and
a movement path of the mobile terminal inside the vehicle.

4. The mobile terminal of claim 1, wherein the first communication unit of the smart key module receives a vehicle signal indicating at least one of an opening or closing of vehicle doors, an opening or closing of vehicle windows, or a vehicle driving record, and
wherein the vehicle doors and windows comprise a right front, right rear, left front, and left rear door and window in the vehicle.

5. The mobile terminal of claim 4, wherein the controller is further configured to execute the payment application automatically when detecting at least one among:
the vehicle switches from a driving state to a stop state,
the left front door corresponding to a driver of the vehicle is closed, and
the left front window corresponding to the driver of the vehicle is open.

6. The mobile terminal of claim 1, wherein the controller is further configured to:
determine if a payment event is occurring based on at least one of a current position of the vehicle, a vehicle state and a movement path of the mobile terminal, and
automatically execute the payment application without user interaction when determining the payment event is occurring.

7. The mobile terminal of claim 6, wherein when the vehicle state indicates the vehicle is stopped, a door of the vehicle corresponding to a driver is closed, and a window of the vehicle corresponding to the driver is opened, the controller automatically executes the payment application based on the movement path of the mobile terminal.

8. The mobile terminal of claim 7, wherein when the movement path of the mobile terminal moves from an inside of the vehicle through the opened window, the controller automatically executes the payment application.

9. The mobile terminal of claim 8, wherein when the movement path of the mobile terminal further moves back inside of the vehicle through the opened window, the controller is further configured to display a payment result of a payment made for the payment event.

10. The mobile terminal of claim 1, wherein the controller is further configured to:
when a current location indicates the vehicle has stopped at a gas station, receive vehicle fuel data from the vehicle, and
when the vehicle fuel data indicates an amount of fuel in the vehicle is increasing and then does not change for more than a predetermined period of time after the amount of fuel has increased, automatically execute the payment application.

11. A mobile terminal, comprising:
a Passive Key Entry (PKE) module configured to communicate with a vehicle through a PKE communication protocol; and
a controller configured to determine a state of the vehicle and a position of the mobile terminal with respect to the vehicle based on a vehicle PKE signal received through the PKE module, and to determine a payment event based on the state of the vehicle and the determined position of the mobile terminal; and
a payment processing unit configured to execute a payment application at the payment event, wherein the payment application outputs user authentication information and payment processing information when a partner terminal or a high-pass gate requests payment, and processes the payment.

12. The mobile terminal of claim 11, wherein the controller is further configured to calculate the position of the mobile terminal by substituting RS RI obtained from LF antenna signals received sequentially from the vehicle into a triangulation equation.

13. The mobile terminal of claim 11, wherein, when a movement path along which the mobile terminal moves from an inside of the vehicle to an outside of the vehicle while vehicle doors are closed and at least one vehicle window is opened is detected based on data received from the vehicle through the PKE module, the controller is further configured to execute the payment application.

14. The mobile terminal of claim 13 wherein, when the movement path along which the mobile terminal moves from the outside of the vehicle back to the inside of the vehicle after payment while the vehicle doors are closed and the at least one vehicle window is opened is detected based on data received from the vehicle through the PKE module, the controller is further configured to display a payment completion message generated by the payment application on a screen of the mobile terminal.

15. The mobile terminal of claim 14, wherein, when the movement path along which the mobile terminal moves again from the inside of the vehicle to the outside of the vehicle is detected within a predetermined period of time after the movement path along which the mobile terminal moves from the outside of the vehicle back to the inside of the vehicle is detected, the controller is further configured to execute the payment application.

16. The mobile terminal of claim 11, wherein the controller is further configured to determine an amount of fuel of the vehicle based on data received from the vehicle through the PKE module and to execute the payment application when no further increase of fuel is detected after the amount of fuel has been increased, and
wherein, if the position of the mobile terminal is determined to be in a vicinity of a fuel tank cap of the vehicle when no further increase of fuel is detected after the amount of fuel has been increased, the controller is further configured to execute the payment application.

17. The mobile terminal of claim 11, wherein the PKE module is further configured to receive toll payment information from a high-pass terminal through the vehicle,
wherein the controller is further configured to pay the toll by executing the payment application when the high-pass gate is detected and to transmit a payment completion message generated by the payment application to the vehicle through the PKE module; and
wherein the high-pass terminal is configured to transmit the payment completion message received through an electronic control unit of the vehicle to the high-pass gate.

18. The mobile terminal of claim 11, further comprising:
a V2X module configured to communicate with the high-pass gate, wherein toll payment information is received from the high-pass gate through the V2X module, and
wherein the controller is further configured to pay a toll by executing the payment application when the high-pass gate is detected and to transmit a payment completion message generated by the payment application to the high-pass gate.

19. The mobile terminal of claim 18, wherein the controller is further configured to detect the position of the mobile terminal in which the V2X module is embedded within the vehicle based on a signal received through the PKE module and to output a position change guide when the position of the mobile terminal is not an optimal position providing a highest reception ratio of the high-pass gate signal.

20. A method of payment using a mobile terminal communicating with a vehicle through Passive Keyless Entry (PKE) communication protocol, the method comprising:
determining a vehicle state and a position of the mobile terminal with respect to the vehicle based on LF antenna signals received sequentially through a PKE module from the vehicle;
determining a payment event based on the vehicle state and the position of the mobile terminal; and
executing a payment application at the payment event and performing payment requested by a partner terminal or a high-pass gate.
